(19) United States
(12) Patent Application Publication
(10) Pub. No.: US 2009/0322164 A1
(43) Pub. Date: Dec. 31, 2009

(54) Vibrating method for generating direct current electricity

(76) Inventor: Gary Dennis Porter, Malabar, FL (US)

Correspondence Address: Gary Dennis Porter, 2150 Valkaria Rd., Malabar, FL, 32950, US

(21) Appl. No.: 12/215,394

(22) Filed: Jun. 27, 2008

(51) Int. Cl. H02K 33/10; H02K 53/00

(52) U.S. Cl. 310/31; 74/DIG. 9

(57) ABSTRACT

The present invention utilizes a contact vibrating technique to generate Direct Current electricity from a battery and coils. The present invention utilizes BEMF (Back Electro Motive Force) to recharge the battery that runs the device. No external charge is ever required to maintain the battery. The present invention utilizes three cycles of operation. The first cycle provides power into the primary coil. The second cycle opens contacts allowing the primary coil to generate BEMF oscillations. Both the positive and negative BEMF pulses from the primary are collected and stored in capacitors. The positive pulses are stored in a smaller capacitor. Also during the second cycle, the secondary coils and associated circuitry collect both the positive and negative pulses from the etheric oscillations, which occur due to the BEMF ringing of the primary magnetic field returning to the zero state. The third operation occurs, when the second set of contacts close and a capacitive discharge pulse recharges the primary battery back to its normal operating level. The cycles are then repeated in a vibrating fashion.

### FIELD OF THE INVENTION

The present invention relates to vibrating electrical devices, that generate Direct Current Electricity.

### BACKGROUND OF THE INVENTION

Heretofore, Direct Current electricity has typically been generated by rotating devices. These current methods are costly, inefficient, and require expensive replacement of frictional parts; such as shafts, brushes, and bearings.

After, a thorough search of patents in all pertaining classes and subclasses, no known device exists based on the present inventions concept utilizing vibrating contact techniques for the generation of Direct Current electricity.

All Direct Current Generator Devices found utilize rotational techniques to create Direct Current electrical energy.

Challenges exist in the creation of Direct Current electricity without the use of these rotating devices.

### SUMMARY OF THE INVENTION

The needs set forth above as well as further and other needs and advantages of the present invention are achieved by the embodiments of the invention described herein below.

In one embodiment of the present invention, a method for generating Direct Current electricity is accomplished utilizing vibrating mechanical contacts. One common moveable contact vibrates and makes contact with two other fixed contacts. One of the fixed contacts is normally closed to the moveable contact and the other fixed contact is normally open.

The present invention utilizes a power phase, energy collection phase, and a battery recharging phase during its operation.

The first phase sends battery energy through the moveable contact into the normally closed fixed contact, the latter being connected to a primary coil.

The energy flows through the primary coil and generates a magnetic field. This magnetic field in turn pulls on a piece of iron or magnet attached to the moveable contacts flexible support bar. The pulling action opens the moveable and fixed contacts, which removes the battery from the primary coil.

While the battery is being disconnected from the primary coil, which constitutes the energy collection phase, the primary coils magnetic field collapses trying desperately to maintain the existing magnetic field current. The collapsing magnetic field creates several very large magnetically induced oscillating electrical pulses. These pulses are known as BEMF (Back Electro Motive Force) pulses. These BEMF pulses will oscillate and dissipate in a dampened fashion until they reach the zero point.

The BEMF pulses, allow the present invention to accomplish two things, one of which is to recharge the battery and the other is to allow the secondary coils to create additional energy through magnetic induction between the secondary and primary coils. Since this oscillation occurs during the time when the battery is disconnected from the primary coil, no loading by the secondary components will affect the battery in any way.

The oscillating output from the present inventions secondary coils Is rectified using diodes and then stored in capacitors. The Direct Current stored in the capacitors can now be utilized by numerous electrical devices to perform work.

The present invention is not limited to one secondary coil, one primary coil, the length of the primary coil, or thickness of the secondary coils. The thickness of the secondary coils will determine the number of secondary coils that can be used by the present invention. The secondary coils utilized by the present invention are extremely flat in nature and these are placed over the entire length of the primary coil thus taking advantage of all of the oscillating magnetic flux created by the primary coils changing magnetic field.

The present invention utilizes a conventional rechargeable battery to start its initial operation. Through proper energy feedback, capturing, and processing techniques, the present inventions battery can be detached or switched out of the system, once the initial charge has been placed into the system and the system is functioning properly. The energy captured from the oscillating and stressed etheric movement in the vacuum is quite sufficient to maintain the systems operation indefinitely.

### BRIEF DESCRIPTION OF THE DRAWINGS

FIG. 1 is a schematic diagram of the embodiment of the present invention. All the pieces required to build the present invention are shown. An additional magnet or piece of iron not shown can be placed near the permanent magnet to enhance the vibrating arms motion and frequency. Anyone skilled in the art will be able to build this system from the drawing and the detailed description of the present invention that follows.

FIG. 2 is a waveform printout. It shows two oscilloscope channels where CH1 displays the state and voltage level of the battery and CH2 displays the collection and discharging of energy to the battery.

### DETAILED DESCRIPTION OF THE INVENTION

Embodiments according to the present invention are utilized in the generation of Direct Current electricity. This Direct Current electricity is stored in capacitors. This stored electricity can be used to do work in other devices. The devices drawing energy form the present inventions capacitors will be required to utilize resonant circuits, pickup coils, and BEMF (back electro motive force) collection techniques to maintain proper operation.

The present invention is self sustaining and its battery requires no recharging from external sources.

The present invention has three cycles of operation; power, energy collection, and battery recharge. During the power cycle energy is taken from the battery through the closure of contacts and used to create a magnetic field in the primary coil. When the contacts open, the battery is disconnected from the primary coil and both BEMF positive and negative energy pulses are collected and stored in capacitors. Also during the energy collection process, the secondary coils generate electrical energy through the induction process that occurs between the primary and secondary coils. The entire energy collection process occurs while the battery is disconnected from the system. During the battery recharge cycle, collected positive BEMF energy stored in a capacitor is discharged back into the battery.

The three cycles are repeated in a vibrating fashion. The frequency of the vibration is determined by contact travel distance, contact support arm strength, primary coil magnetic strength, and other factors.

Power coils BEMF can provide very large oscillations between 400 volts negative and 375 volts positive. The present invention was developed using a 1.2 NiCad AA rechargeable battery. The primary BEMF positive portion maintained the battery level at 1.252 volts DC. The maximum charge that the 1.2 AA NiCad can hold is 1.260 volts DC. During the present inventions vibration, the primary side second capacitor gathered negative 117 volts DC.

The Direct Current electricity generated by the present inventions secondary coils contains very little charge carriers. The output of the secondary coils takes time to charge the output capacitors. The energy seems to be electrostatic in nature. The energy stored in the capacitors, when discharged into other circuits is powerful, but it must be remembered that it takes time to refill the capacitors.

For this reason output devices connected to the present invention must be able to use resonance techniques to assist in maintaining the level in the present inventions output capacitors. This is accomplished using push pull techniques, where one group of the present inventions output capacitors can provide negative energy pulses to half of the load device and another group of the present inventions output capacitors can provide positive energy pulses to a second half of the load device. The BEMF energy from these capacitive discharges into inductive loads can be used to refill both the present inventions output negative and positive capacitors. One skilled in the art can use many different arrangements to accomplish the energy recovery.

The present invention came from a simple experiment where a coil of wire was pulsed from a battery. The key to the present invention working and being able to keep the battery charged directly relates to the events that occur after the battery is disconnected from the coil.

The Ether in the Vacuum is stressed and expanded from its original steady state, when a magnetic field is created by the flow of energy through the coil. When the battery is disconnected from the coil, the Ether is no longer stressed and can return to its original steady state. The Ether will oscillate in a dampened resonant fashion producing a ringing event on its way to the original steady state. The frequency of this oscillation is determined by the inductive and capacitive internal components of the primary coil. The dampening time to the steady state is determined by the internal resistance, capacitance, and inductance of the primary coil.

The ringing oscillations are passed from the primary coil to the secondary coils through the process of magnetic induction. Voltage levels achieved during the initial portion of the ringing event in the primary coil can reach a negative level of 400 volts and a positive level of 375 volts from a positive input into the primary coil. If a negative input is driving the primary coil then a positive level of 400 volts and negative level of 375 volts can be achieved.

The ringing events in both the primary coil and secondary coils appear to be electrostatic in nature until they are rectified and stored in the capacitors at which time they become electric charge. The accumulated charge in the capacitors can then be used to recharge the primary coil battery and do work in the secondary coils output section.

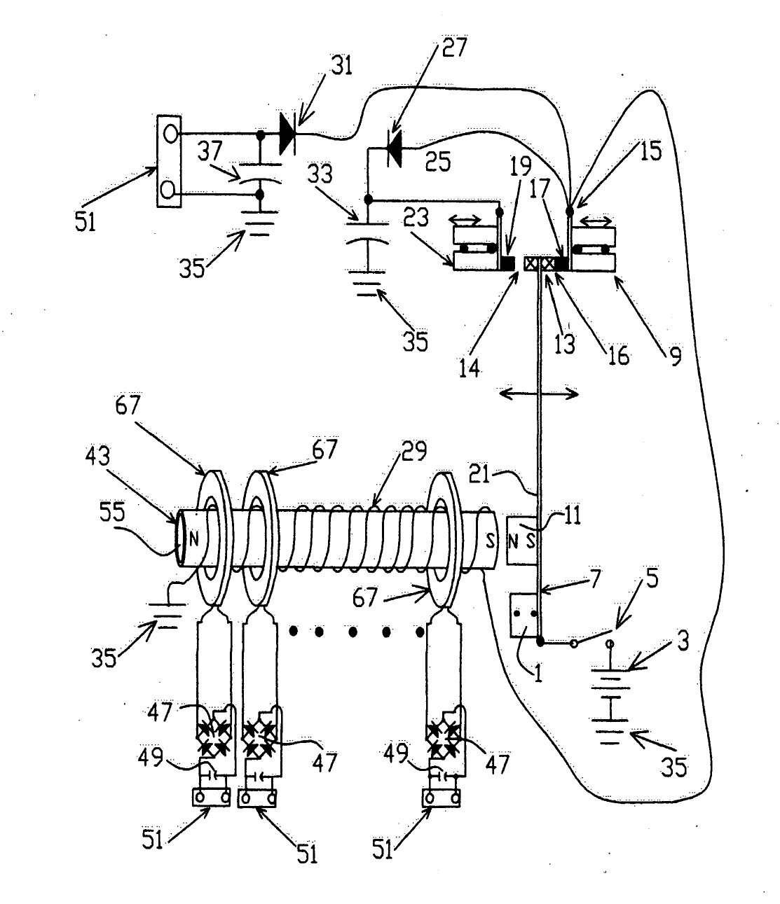

FIG. 1 is a schematic drawing showing the components used in the present invention. Not shown in FIG. 1 is a small magnet or piece of iron, that can be placed in the vicinity of magnet 11. This additional small magnet or piece of iron can assist in returning the moveable contact 13 to its original position making contact with 17. The use of this small magnet or piece of iron will also affect the frequency of operation. The small magnet or piece of iron must be placed near the South Pole of magnet 11. The batteries 3 positive terminal is connected to a single pole single throw switch 5. The batteries 3 negative terminal is connected to system ground 35.

There are three contacts used in the present invention two of these 19 and 17 are fixed in position and do not move during operation. Contacts 19 and 17 are adjustable and once there operating position has been established, they can be locked in position using mounts 23 and 9 respectfully. The contact 13 is allowed to swing back and forth and is held in this position by 1. Contact 13 is normally in contact with contact 17 and is then pulled towards and finally making contact with 19. The adjustments made to contacts 19 and 17 must be done in a manner to ensure that the moving contact 13 will make contact to both 17 and 19.

In FIG. 1 items 25, 15, and 21 are thin brass or copper pieces or other none magnetic material. Contacts 13, 17, and 19 can be made of ¼ inch diameter silver rod. The ends making contact should be polished and machined very flat. This ensures that the energy passing through the contacts 13, 17, and 19 will self sequence any arcs which may occur during the contact 13 and 17 openings. Diodes 27 and 31 also help prevent arcing because they provide a pathway for the collection of both the large negative BEMF and positive BEMF pulses that occur when contacts 13 and 17 separate.

Once the switch 5 is closed energy will flow from the battery 3 through the switch 5 to the moveable contact brass or copper piece 21 to contact 13. The energy flows from contact 13 into contact 17 and then through the primary coil 29 to ground 35. The flow of energy through the primary coil 29 creates a magnetic field in the primary coil 29. The primary coils 29 magnetic field pulls on the magnet 11 opening the contact between 17 and 13. The pull by primary coil 29 also brings the contact 13 into contact with 19. During the motion that contact 13 makes between 17 and 19 there is enough time for the diodes 27 and 31 to gather both the positive BEMF pulses and negative BEMF pulse respectfully into capacitors 33 and 37.

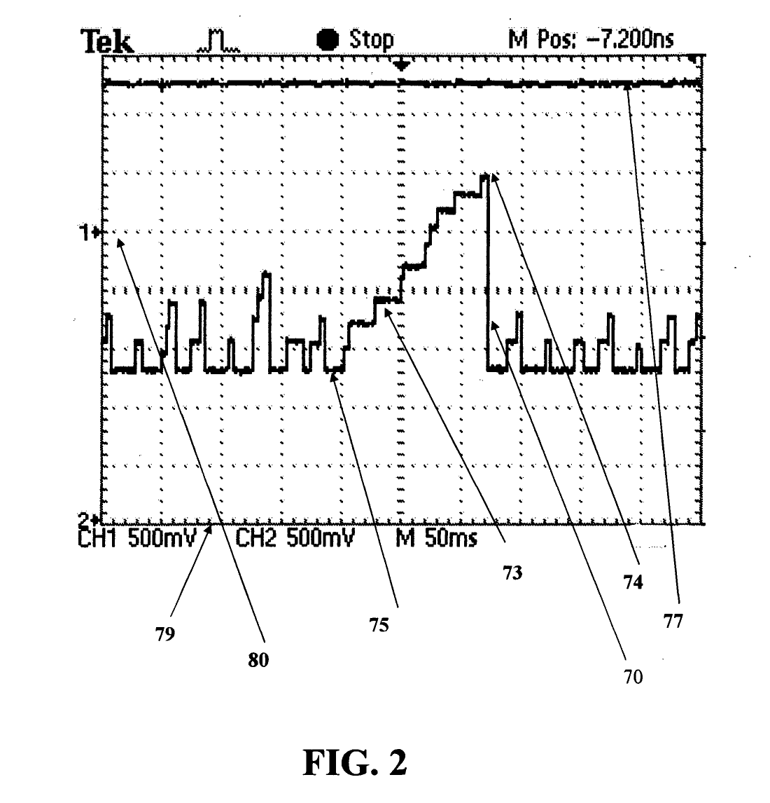

FIG. 2 shows the charging events 73 that occur during the opening of contacts 13 and 17. When contact 13 finally reaches and makes contact with 19 the stored positive BEMF energy in capacitor 33 is discharged into the battery 3 which has been disconnected from the primary coil 29.

The BEMF negative energy collected from the primary coil 29 and stored in capacitor 37 is made available to a load at connector 51 attached to capacitor 37. The voltage level stored in capacitor 37 can reach a level of negative 117 volts DC or greater depending on the capacitor 37 size and quality.

FIG. 1 also shows the secondary coils 67 and their associated bridge rectifiers 47, storage capacitors 49, output connectors 51. There can be numerous secondary coils 67 along with their associated bridges 47 capacitors 49 and output connectors 51. Furthermore, the primary coil 29 can be any length supporting any number of secondary coils 67. The secondary coils 67 should be made as flat as possible and can have any number of turns and any size wire desired to achieve the output goals.

The prototype of the present invention had a primary coil 29 made of 26ga magnetic motor wire with 1000 turns. The primary coil 29 had an air core 55 and iron was not used because it interfered with the primary coils 29 resonating oscillation. The first set of secondary coils 67 used were flat ⅛ inch thick and had 330 turns of 30ga magnetic motor wire. The collected voltage at the output capacitors 49 varied from 5 volts DC to 24 volts DC depending upon the location of the secondary coils 67 along the primary coils 29 axis. The output voltage level increases with the number of turns in the secondary coils 67. The prototype of the present invention also used an 8 microfarad electrolytic capacitor 33. It's important to note that the 8 microfarad capacitor 33 seemed to match the requirements of the battery 3.

FIG. 2 is an oscilloscope waveform printout. The Channel 1 (CH1) reference level 80 is zero volts and the vertical amplitude setting on the oscilloscope for CH1 was 500 millivolts DC per centimeter. The Channel 2 (CH2) reference level 79 is zero volts and the amplitude was set at 500 millivolts DC per centimeter. The battery 3 amplitude is represented by CH1 77. The collection pulses and battery 3 recharging pulses from capacitor 33 are both shown by CH2 73. Capacitor 33 discharges 70 are locked into the battery level 75. The capacitor 33 charging occurs in step fashion 73. The contact 13 and 19 closure is shown at 70. As you can see, the levels collected and stepped 73 into capacitor 33 are quite variable. This variation is caused by the contacts 13 and 19 not making contact during the vibration. During these none contact times, the energy level in capacitor 33 simply steps to a higher level. FIG. 2 shows a maximum achieved of 3 volts DC 74. The capacitor 33 never goes to the zero reference level 79 and ends up discharging to the battery 3 level.

While operating, the present invention prototype maintained a battery 3 operating level of 1.252 volts. The present invention circuitry components can have values, that prevent the system from over charging the battery 3. During the present inventions prototype testing, the output capacitors 49 were all shorted out and this had no effect of the battery operating level and the present invention simply kept vibrating as though nothing had happened. The energy created in the secondary coils 67 is done so after the battery 3 is disconnected when contacts 13 and 17 open.

The present invention can be used singularly or in multiple fashion. The battery 3 size is not limited to any particular battery voltage. The present invention can have a primary coil 29 of any length desired. The present invention can have as many secondary coils 67 as desired.

1. A vibrating device that generates an unlimited supply of Direct Current Electricity, through the use of resonant oscillating magnetic fields, the latter being created by the opening and closing of contacts to a moveable electrically conductive metal bar attaching the power source to and from a primary coil, said device comprised of:
a rechargeable battery or other rechargeable power source providing energy to a primary coil through a moveable electrically conductive metal bar, said moveable electrically conductive metal bar has two ends one moveable and one fixed to a support, the latter is always connected to rechargeable battery or other rechargeable power source; and
a rechargeable battery or other rechargeable power source recharged to its original or suitable stable operating voltage level with energy recovered from the primary coil back electromotive force (BEMF) energy; and

2. A vibrating device of claim 1 utilizing two adjustable fixed contacts separated by moveable electrically conductive metal bar, which moves between the two adjustable fixed contacts said bar and contacts including:
a first adjustable fixed contact positioned to be in contact with the moving end portion of the moveable electrically conductive metal bar, thus producing a normally closed contact situation allowing battery energy to flow to the primary coil as long as the normally closed contact remain in the closed position contacting the moveable electrically conductive metal bar; and
a second adjustable fixed contact positioned directly opposite to the first adjustable fixed contact on the opposite side of the moveable electrically conductive metal bar and located close to but not in contact with the moveable electrically conductive metal bar thus producing a normally open contact; and
the moveable electrically conductive metal bar will vibrate between the first adjustable fixed contact and the second adjustable fixed contact with the latter providing a pathway for recovered stored primary coil (BEMF) energy through moveable electrically conductive metal bar to the rechargeable battery or other rechargeable power source; and
a magnet attached to the moveable electrically conductive metal bar located directly in front of the primary coil end but not in contact with the primary coil end allowing room for the moveable electrically conductive metal bar to vibrate between the fixed contacts.

3. The primary coil of claim 2 will be wound such that the primary magnetic pole facing the magnet attached to moveable electrically conductive metal bar will attract the magnet; and
the magnetic attractive forces between the moveable electrically conductive metal bar magnet and primary coil will be sufficient so that the moveable electrically conductive metal bar will vibrate making contact to both the normally closed and normally open adjustable fixed contacts.

4. The primary coil of claim 3 is fixed in position and has a plurality of flat secondary coils placed along its entire length; and
the flat secondary coils produce electrical energy through transformer action between the flat secondary coils and the primary coil, said energy will then be rectified with bridge rectifier diodes and stored in capacitors.

5-7. (canceled)
